(19) United States
(12) Patent Application Publication
(10) Pub. No.: US 2024/0017685 A1
(43) Pub. Date: Jan. 18, 2024

(54) VEHICLE COMPONENT BASED ON SELECTIVE COMMINGLED FIBER BUNDLE HAVING INTEGRAL ELECTRICAL HARNESS AND EMBEDDED ELECTRONICS

(71) Applicant: J. & P. COATS, LIMITED, Uxbridge (GB)

(72) Inventors: George Han, Uxbridge (GB); Cem Altintas, Uxbridge (GB); Colin Rowbottom, Uxbridge (GB)

(73) Assignee: J. & P. COATS, LIMITED, Uxbridge (GB)

(21) Appl. No.: 18/223,074

(22) Filed: Jul. 18, 2023

Related U.S. Application Data
(60) Provisional application No. 63/390,019, filed on Jul. 18, 2022.

(51) Int. Cl. B60R 16/02; B29C 70/88; B29C 70/46

(52) U.S. Cl. CPC B60R 16/0215; B29C 70/885; B29C 70/46; B29L 2031/3462

(57) ABSTRACT

A form for a vehicle component is provided that includes a commingled fiber bundle composed of a reinforcement fiber. The commingled fiber bundle is laid out in a two-dimensional base layer that defines a shape of the form. A conductive fiber or wire laid in a pattern on the two-dimensional base layer to provide electrical continuity across the form. At least one conductive contact or pad area is built up with overlying layers of the conductive fiber or wire on said two-dimensional base layer. A successive layer is added to embed the conductive fiber or wire and at least one conductive contact or pad area. A conductive fastener is inserted into through hole apertures therein. The conductive fastener is in electrical communication with the corresponding conductive contact or pad area. A method of forming a unitary reinforced composite component is also provided.

### RELATED APPLICATIONS

This application is a non-provisional application that claims priority benefit of U.S. Provisional Application Ser. No. 63/390,019 filed Jul. 18, 2022; the contents of which are hereby incorporated by reference.

### FIELD OF THE INVENTION

The present invention in general relates to composite vehicle components and in particular, to unitary reinforced composite based vehicle components with an integral electrical harness with embedded electronics and associated terminations.

### BACKGROUND OF THE INVENTION

Weight savings in the automotive, transportation, and logistics-based industries has been a major focus in order to make more fuel-efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials.

As vehicles are increasingly platforms for ever more complex sensors and computerized systems, the complexity of a vehicle electrical harness and the time needed for installation have also increased. Traditionally, sets of wires are cut to predetermined lengths and tied into bundles with connectors that must then be joined to structural components during vehicle assembly. Such harnesses have become increasingly impractical and time consuming to couple to not only vehicle electrical components, but also sensors and central processing units (CPUs). Traditional electrical harnesses also suffer from vibrationally induced wear caused by vehicle operation. The shorting of a wire within an electrical harness is difficult to repair.

As part of an effort to reduce vehicle weight, manufacturing has moved towards composite materials. These composite materials include a matrix material that surrounds and supports the reinforcement materials by maintaining their relative positions. The reinforcements impart their special mechanical and physical properties to enhance the matrix properties. A synergism produces material properties unavailable from the individual constituent materials, while the wide variety of matrix and strengthening materials allows the designer of the product or structure to choose an optimum combination.

Commercially produced composites often use a polymer matrix material that is either a thermoplastic or thermoset resin. There are many different polymers available depending upon the starting raw ingredients which may be placed into several broad categories, each with numerous variations. Examples of the most common categories for categorizing polymers include polyester, vinyl ester, epoxy, phenolic, polyimide, polyamide, polypropylene, PEEK, and others.

The use of fiber and particulate inclusions to strengthen a matrix is well known to the art. Well established mechanisms for the strengthening include slowing and elongating the path of crack propagation through the matrix, as well as energy distribution associated with pulling a fiber free from the surrounding matrix material. In the context of sheet molding composition (SMC) formulations, bulk molding composition (BMC) formulations, and resin transfer molding (RTM); hereafter referred to collectively as “molding compositions”, fiber strengthening has traditionally involved usage of chopped glass fibers. There is a growing appreciation in the field of molding compositions that replacing in part, or all of the glass fiber in molding compositions with carbon fiber can provide improved component properties.

Fiber-reinforced composite materials can be divided into two main categories normally referred to as short fiber-reinforced materials and continuous fiber-reinforced materials. Continuous reinforced materials often constitute a layered or laminated structure. The woven and continuous fiber styles are typically available in a variety of forms, being pre-impregnated with the given matrix (resin), dry, uni-directional tapes of various widths, plain weave, harness satins, braided, and stitched. Various methods have been developed to reduce the resin content of the composite material, by increasing the fiber content. Typically, composite materials may have a ratio that ranges from 60% resin and 40% fiber to a composite with 40% resin and 60% fiber content. The strength of a product formed with composites is greatly dependent on the ratio of resin to reinforcement material. The construction method of selective placement of commingled fiber bundles being stitched in place offers new opportunities to integrate electrical wiring within a vehicle component.

While there have been many advances in composite materials with embedded electrical conductors there continues to be a need for simplified through hole terminations and blind via terminations that connect to external electrical harnesses, electrical components, and additional composite structures having embedded conductors.

### SUMMARY OF THE INVENTION

A form for a vehicle component is provided that includes a commingled fiber bundle composed of a reinforcement fiber. The reinforcement fiber being glass fibers, aramid fibers, carbon fibers, or a combination thereof. The commingled fiber bundle is laid out in a two-dimensional base layer that defines a shape of the form. A conductive fiber or wire laid in a pattern on the two-dimensional base layer to provide electrical continuity across the form. At least one conductive contact or pad area is built up with overlying layers of the conductive fiber or wire on said two-dimensional base layer. A successive layer formed with the commingled fiber bundle in contact with said two-dimensional layer so as to embed the conductive fiber or wire and at least one conductive contact or pad area. A through hole aperture corresponding to each of the at least one conductive contact or pad areas. A conductive fastener is inserted into each of the through hole apertures. The conductive fastener is in electrical communication with the corresponding conductive contact or pad area.

A method of forming a unitary reinforced composite component is provided that includes a form being placed onto a mold platen having a shape. The form is heated to assume the shape of the mold platen. The perform is then cooled until solidified. The shaped form is then removed from the mold platen.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic illustrating a selective commingled fiber bundle positioning (SCFBP) form created from a continuous fiber bundle inclusive of electrical wiring according to the present invention;

FIG. 2 is a cross section representation of a SCFBP form, where C stands for a carbon fiber rich commingled fiber bundle, G stands for glass fiber rich commingled fiber bundle, and W stands for an electrical distribution wire in accordance with embodiments of the invention;

FIG. 3 is a schematic illustrating a SCFBP form created according to the present invention inclusive of a printed circuit board (PCB);

FIG. 4 is a top view of a preform with a stitched conductor an embedded antenna with external electrical terminations for connection to a control board and touch sensor and a light emitting diode (LED) in accordance with embodiments of the invention;

FIG. 5A is a top view of a preform with stitched LED strips with a termination for a ribbon cable in accordance with embodiments of the invention;

FIG. 5B is a top schematic view of FIG. 5A in accordance with embodiments of the invention;

FIG. 6 is an exploded view of a layered composite structure with an embedded conductive fiber or wire laid in a pattern to provide electrical continuity across the composite structure in accordance with embodiments of the invention;

FIG. 7A is a top view of the layered composite structure of FIG. 6 with the embedded conductive fiber or wire and built-up contact pad area shown as dashed lines in accordance with embodiments of the invention;

FIG. 7B illustrates a through hole aperture made in the contact pad area of the embedded conductive fiber or wire of the layered composite structure of FIG. 6 in accordance with embodiments of the invention;

FIG. 7C is a partial cross section of the layered composite structure of FIG. 7B along line A-A in accordance with embodiments of the invention;

FIG. 7D is a partial cross section of the layered composite structure of FIG. 7B along line A-A with a conductive fastener inserted into the through hole aperture in the composite structure and an external wire positioned for securement to the conductive fastener in accordance with embodiments of the invention;

FIG. 7E is a partial cross section of the layered composite structure of FIG. 7B along line A-A with the conductive fastener fully engaged in the through hole aperture in the composite structure and the external wire secured to the conductive fastener in accordance with embodiments of the invention;

FIGS. 8A-8D are a series of partial cross-sectional views showing the insertion of a different conductive fastener in accordance with embodiments of the invention;

FIGS. 9A-9C are a sequence of schematic steps of processing an inventive SCFBP form into a vehicle component by melting thermoplastic content of the SCFBP form; and

FIGS. 10A-10G are photographs of an implementation a layered composite structure with embedded conductive fiber or wire and external contact terminals in accordance with embodiments of the invention.

### DESCRIPTION OF THE INVENTION

The present invention has utility as a through hole or blind via termination for embedded conductive fiber or wire that is integrated within a laminate structure of a composite part. In embodiments of the invention, the conductive fiber or wire is laid in a pattern to provide electrical continuity across the composite part. At the ends of the conductive fiber or wire, extra fiber or wire material is added across an area set by manufacturing tolerances to establish a set of contact points or conductive pads. In specific embodiments selective commingled fiber bundle positioning (SCFBP) may be used to lay the conductive fiber or wire in a pattern on the surface of a laminate structure. The laminate structure is molded with the conductive fiber or wire within. Holes are drilled through the areas of added conductive fiber or wire that form the contact points or conductive pads, exposing the core of the conductive fiber or wire. A conductive fastener, such as a copper rivet, is installed in the drilled hole, extending electrical continuity to the conductive fastener and providing an electrical surface termination. Conductive materials, such as a wiring harness, can then be connected to the installed conductive fastener to further extend the electrical continuity to other circuitry components.

Specific embodiments of the invention utilize a unitary reinforced composite based panel component, and methods of construction thereof inclusive of electrical wiring and associated embedded electrical components. A vehicle component is prepared with resort to selective commingled fiber bundle positioning (SCFBP) to selectively place commingled fibers that are in some inventive embodiments enriched in carbon fiber as a reinforcement relative to other region that rely on a relatively higher percentage of glass fiber reinforcement while internalizing electrical wiring and associated electrical components within the vehicle part. By providing external terminations to an internalized or an external electrical harness function for a vehicle part, vehicle assembly is simplified and vibrationally induced wear observed in a traditional electrical harness is eliminated.

In specific inventive embodiments, commingled reinforcing fibers of glass, carbon, polyaramid, or a combination thereof are used to form a yarn that has predictable strength, and where the ratio of different fiber types is varied to create different properties along a given length. According to embodiments, the commingled fiber-based yarn optionally also includes a plurality of thermoplastic threads commingled with the reinforcing fibers in the yarn. The commingled fiber-based yarn may be used in the formation of the SCFBP forms and are able to be embroidered directly into complex shapes thereby eliminating trimming waste and inefficient usage of comparatively expensive carbon fiber. In specific inventive embodiments, SCFBP forms include from 3 to 20 layers that vary in fiber types in three dimensions (3D). Electrically conductive insulated wire is also stitched by the SCFBP process into the form to create preselected electrical pathways. The final panel is them formed by melting any thermoplastic fibers within the SCFBP form in contact with at least one mold platen complementary to the finished vehicle component to form a vehicle panel such as a dashboard, body panel, door component, roof components, or decklids.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

SCFBP-technology offers several advantages including:
varying the angle of fiber positioning during the lay-up process freely between 0 and 360°;
repeated fiber positioning on the same area allows for local thickness variations in the fiber form suited for a fiber composite component,
the conversion of the desired fiber orientation in a fiber positioning pattern for an embroidery machine requires minor development times and costs,
the process allows a near-net-shape production, which results in low waste and optimal fiber exploitation,
the ability to process a variety of fibers such as natural, glass, aramid, carbon (high strength and high modulus) and ceramic fibers.

As used herein, a veil includes woven sheets, non-woven sheets, and films of thermoplastics, glass, or aramids; or woven sheets, non-woven sheets of carbon fibers.

As used herein, any reference to weight percent or by extension molecular weight of a polymer is based on weight average molecular weight.

As used herein, the term melting as used with respect to thermoplastic fibers or thread is intended to encompass both thermofusion of fibers such that a vestigial core structure of separate fibers is retained, as well as a complete melting of the fibers to obtain a homogenous thermoplastic matrix.

Commingled fibers as a roving are made up of commingled reinforcing fibers, illustratively including those made of carbon, glass, or aramid fibers, and optionally thermofusible fibers which serve to provide a matrix in a composite material made of both reinforcing and matrix fibers. The optional matrix fibers, being of a thermofusible nature may be formed from material such as, for example, polyamide, polypropylene, polyester, polyether ether ketone, polybenzobisoxazole, or liquid crystal polymer. The reinforcing fibers may also be of a material that is meltable with the proviso that melting occurs at a temperature which is higher than the any matrix fibers so that, when both fibers are used to create a composite, at the temperature point at which melting of the matrix fibers occurs, the state of the reinforcing fibers is unaffected.

According to embodiments the commingled fibers are made up of only reinforcing fibers and not thermoplastic fiber. The reinforcement fibers in a commingled fiber bundle being glass fibers, polyaramid, carbon fibers, or a combination of any of the aforementioned. It is appreciated that the commingled fibers are either parallel to define a roving or include some fibers that are helically twisted to define a yarn. It is appreciated that the physical properties of reinforcing fibers retained in a helical configuration within a fixed matrix of a completed vehicle component are different than those of a linear configuration, especially along the reinforcing fiber axis.

According to further embodiments, the commingled fibers used in the present invention are composed of both thermoplastic fibers and a reinforcement fiber. Thermoplastic fibers operative herein illustratively includes, polypropylenes, polyamides, polyesters, polyether ether ketones, polybenzobisoxazoles, polyphenylene sulfide; block copolymers containing at least of one of the aforementioned constituting at least 40 percent by weight of the copolymer; and blends thereof. The optional thermoplastic fibers are appreciated to be recycled, virgin, or a blend thereof. The thermoplastic fibers in a commingled fiber bundle constitute from 20 to 80 weight percent of the commingled fibers in the present invention. The relative number of reinforcing fibers relative to any thermoplastic fibers present is highly variable in the present invention in view of the disparate diameters of glass fibers, polyaramid fibers, and carbon fibers.

An inventive form is created by laying out one or more commingled fiber bundles on a substrate as a two-dimensional base layer that defines a shape of the form with stitching applied to retain the commingled fibers in a desired placement on the substrate. As is conventional to SCFBP, the substrate can be removed after production of the form, else it is retained and thereby incorporated into the resulting vehicle component. According to embodiments of the present invention, the stitching thread is a thermoplastic thread, glass fiber thread, carbon fiber thread, aramid fiber thread, a metal wire, or a combination thereof. The thread diameter and thread material used for stitching are variables that are readily selected relative to the properties of commingled fiber bundle and the desired properties of the resulting preform and vehicle component. In certain inventive embodiments, the stitching is a thermoplastic thread. The thermoplastic thread in some inventive embodiments is formed of the same thermoplastic present in the commingled fiber bundle. It is appreciated that the thread diameter and melting temperature of the thread used for stitching are variables that are readily selected relative to the properties of the commingled fiber bundle.

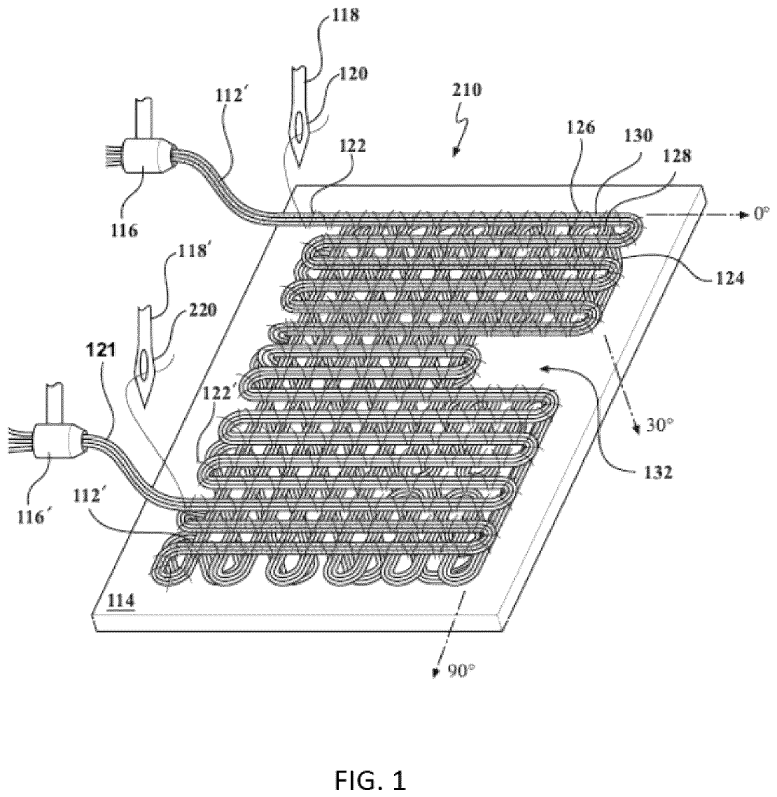

As shown in FIG. 1, an inventive form is shown generally at 210 is in the process of being created. The commingled fiber bundle 112 is conveyed to a substrate 114 by a guide pipe 116 to lay out the commingled fiber bundle 112 in predetermined pattern on the substrate 114. A conventional sewing machine head operating a needle 118 with a top thread 120 tacks the commingled fiber bundle 112 with stitches 122. A bobbin below the substrate 114, includes a bobbin with a lower thread is not shown, and is conventional to sewing machines. The top thread 120 and the bottom thread are thermoplastic thread, glass fiber thread, carbon fiber thread, aramid fiber thread, a metal wire, or a combination thereof. In certain inventive embodiments, the commingled fiber bundle 112 is laid out in a base layer 124 in generally parallels lines with a given orientation. Switchback turn regions 126 are commonly used to lay out parallel lines of commingled fiber bundle 112. A base layer 124 has an orientation of 30 degrees, while a first successive layer 128, and a second successive layer 130 have orientations of 90 degrees and 0 degrees, respectively. This is best seen in the notch region 132 in the form 210. A second conventional sewing machine head' operating a needle 118′ with a top thread 220 tacks an electrical wiring 121 with stitches 122′. The electrical wiring 121 is bare electrically conductive wiring, insulated electrical wiring, and a coil of either of the aforementioned around a carrier fiber or bundle of carrier fibers. The electrical wiring 121 is readily formed from conventional materials such as copper, copper alloys, stainless steel, galvanized steel, aluminum, aluminum alloys, and gold. A second bobbin below the substrate 114, includes a bobbin with a lower thread is not shown, and is conventional to sewing machines. The top threads 120 and 220, can be the same or different and likewise the bottom threads. The needle 118 in FIG. 1 is devoted to only applying a uniform commingled fiber bundle 112. While only two separate sewing heads are shown in FIG. 1, it should be appreciated that additional sewing heads are readily used to simultaneous stitch commingled fiber bundles to create a form or to vary the amount or type of reinforcing fiber relative to the bundle 112. This being especially the case when the form is for a large area form as might be employed in a vehicle component such as a floor.

As a result of the present invention, the form 210 includes specific features such as the notch region 132 that conventionally would be cut from a base piece. In this way, the present invention eliminates the cutting step, as well as the associated waste generation while including electrical wiring within the form. In addition to the substantially linear pattern of commingled fiber bundle positioning depicted in FIG. 1 with interspersed switchbacks, it is appreciated that other patterns operative herein illustratively includes spirals, and any space filling curve such as a Peano curve, dragon curve, or Sierpinksi curve.

If zero degrees is defined as the long axis of the base layer 124, the subsequent layers are overlaid at angles of 0-90°. For example, an angular displacement between adjacent layers is 450 resulting in a 0-45-90-45-0 pattern of layers. Further specific patterns illustratively include 0-45-90-45-0, 0-45-60-60-45-0, 0-0-45-60-45-0-0, 0-15-30-45-60-45-30-15-0, and 0-90-45-45-60-60-45-45-90-0. While these exemplary patterns are for from 5 to 10 layers of directional SCFBP, it is appreciated that the form 210 may include from 3 to 20 layers. It is appreciated that the form layers may be symmetrical about a central layer, in the case of an odd number of layers, or about a central latitudinal plane parallel to the players.

The stitching 122 or 122′ is applied with a preselected tension, stitching diameter, stitch spacing. The stitching 122 or 122′ is typically present in an amount of from 0.1 to 7 weight percent of the commingled fiber bundle 112′ or wiring 121, respectively.

While FIG. 1 only shows three layers, it is appreciated that a form 210 is readily formed with up to 20 layers with the only technical limit being the length of the travel of the needle 118.

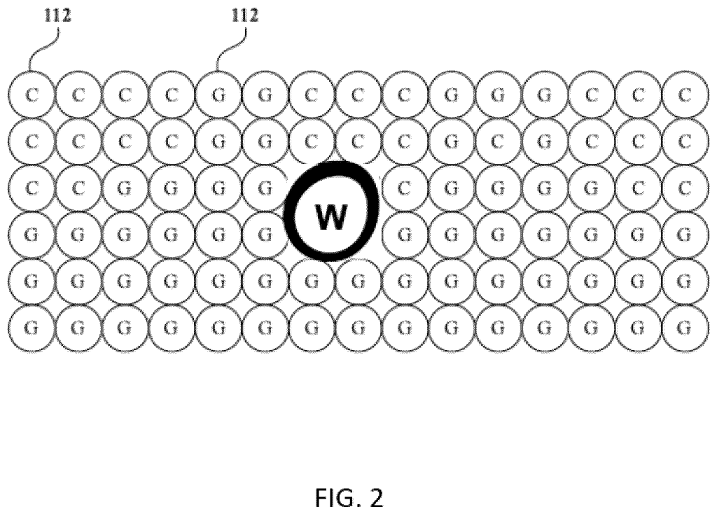

A cross-sectional view of an exemplary form similar to form 210 is shown in FIG. 2 with six layers, where C denotes a carbon fiber enriched commingled fiber bundle 112, G denotes a carbon fiber depleted commingled fiber bundle 112 to illustrate regions of selective toughening to enforce the edges and center of the form, and W denotes wiring 121. In this way carbon fiber is used efficiently to toughen while the part includes electrical wiring. In contrast to the form 210, with adjacent layers varying in angle, FIG. 2 shows the adjacent layers parallel for visual clarity. No stitches are shown for visual clarity.

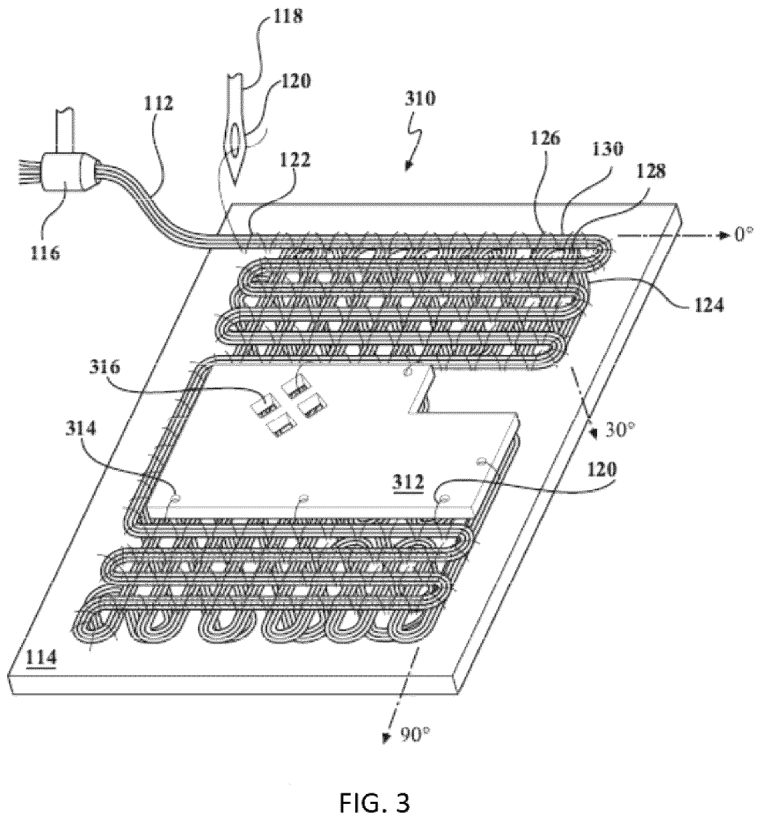

As shown in FIG. 3, in which like reference numerals have the meaning previously ascribed thereto, an inventive form 310 is in the process of being created. This embodiment varies from that detailed with respect to FIG. 1 in that a printed circuit board (PCB) 312 is stitched into the form 310. Preformed holes 314 in the PCB 312 are present in certain inventive embodiments that are sized and spaced to receive thread 120. In still other inventive embodiments, a veil is overlaid on the top surface of form 310 to encompass a top layer strut in thermoplastic material.

While the inclusion of a PCB 312 in a form is illustrated in FIG. 3 relative to FIG. 1, it is appreciated that a PCB 312 is also readily employed with devoted sewing head. It is further appreciated that the PCB 312 is prepopulated with electrical components that are soldered to the PCB 312 with a solder having a melting point above the temperature at which over-molding of the form 310 occurs.

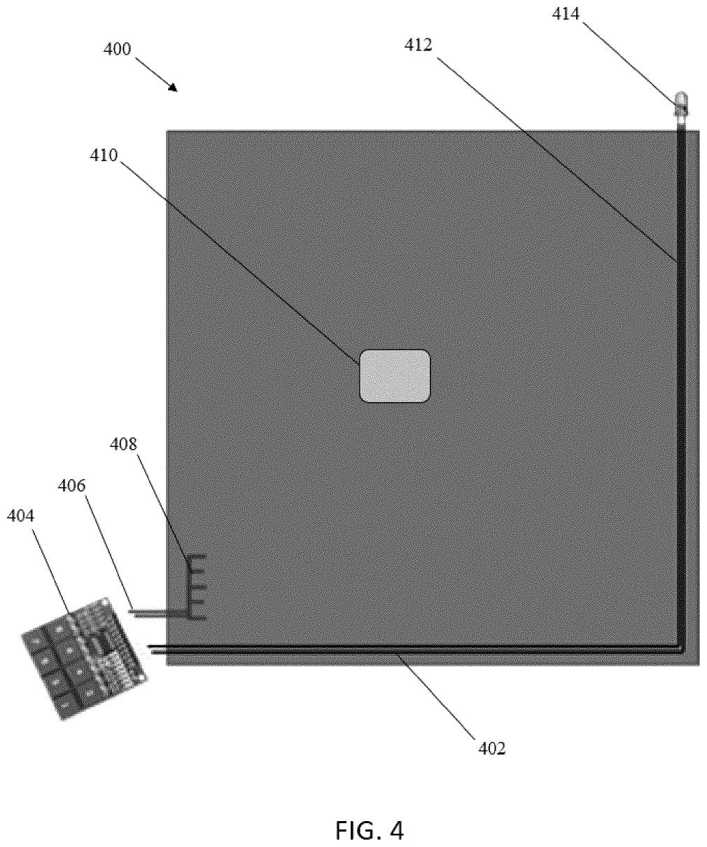

FIG. 4 is a top view of an inventive preform 400 with a stitched conductor 402 formed of the electrical wiring as detailed above that also forms an embedded antenna 408. A light emitting diode (LED 414) is in electrical communication with the conductor 402 and can be activated based on antenna activation associated with receipt of a wireless signal that for example, is associated with the proximity of a key fob for a vehicle. External electrical terminations 406 serve as a connection to a control board and/or touch sensor 404 that controls the LED 414. In a specific embodiment the control board may be on a flexible circuit board. Also shown in FIG. 4, a radio frequency identification (RFID) chip 410 is stitched to the preform 400. It is also appreciated that sensors illustratively including capacitive touch sensors, temperature sensors may be integrated into embodiments of the preform 400. Once the wires and electrical components are sewn into place, the resulting preform is subjected to conventional molding techniques such as thermoplastic compression overmolding, thermoset compression overmolding, or resin transfer molding (RTM). Non-limiting examples of where inventive composite assemblies may be used in a vehicle illustratively include the dashboard, roof, and doors, a dashboard, or a central console. The inclusion of wireless antennae and independent powers sources (battery, solar cell, wind driven dynamo power) allow for independent function from the electrical system of the vehicle chassis for assemblies illustratively including a lift gate, detachable roof, door, etc., without running physical wires, which are prone to wear and failure at connection points. In addition to improved long-term reliability, the manufacturing and assembly of the vehicle is simplified.

According to embodiments of the present invention, an inventive preform is suitable to use with any known composite component processing technique, such as RTM, LCM, thermoplastic overmolding, injection molding, and the like.

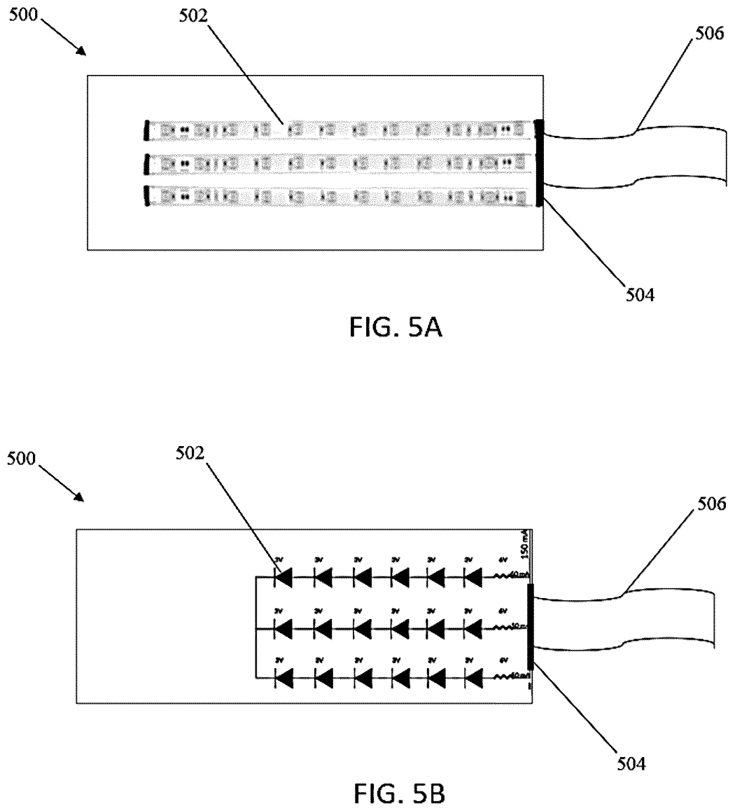

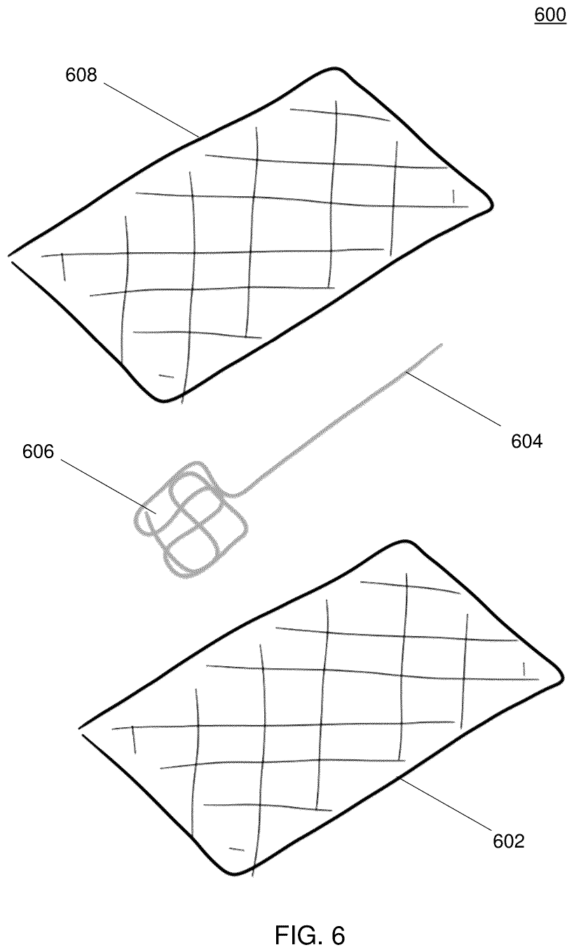

FIG. 5A is a top view of an embodiment of an inventive preform 500 with stitched LED strips 502 with an electrical termination 504 for joining a ribbon cable 506. The preform 500 may be overmolded with a clear or transparent thermoplastic for use as a turn signal or rear vehicle brake light. Alternatively, only the backside of the preform may be melted into thermoplastic for joining to a lens cover. In a further inventive embodiment, a surface cloth with cutouts may be used for the LED strips 502 that provides a quick route to a vehicle roof interior. FIG. 5B is a top schematic view of FIG. 5A showing the electrical connections in the LED strips 502 and the electrical termination 504.

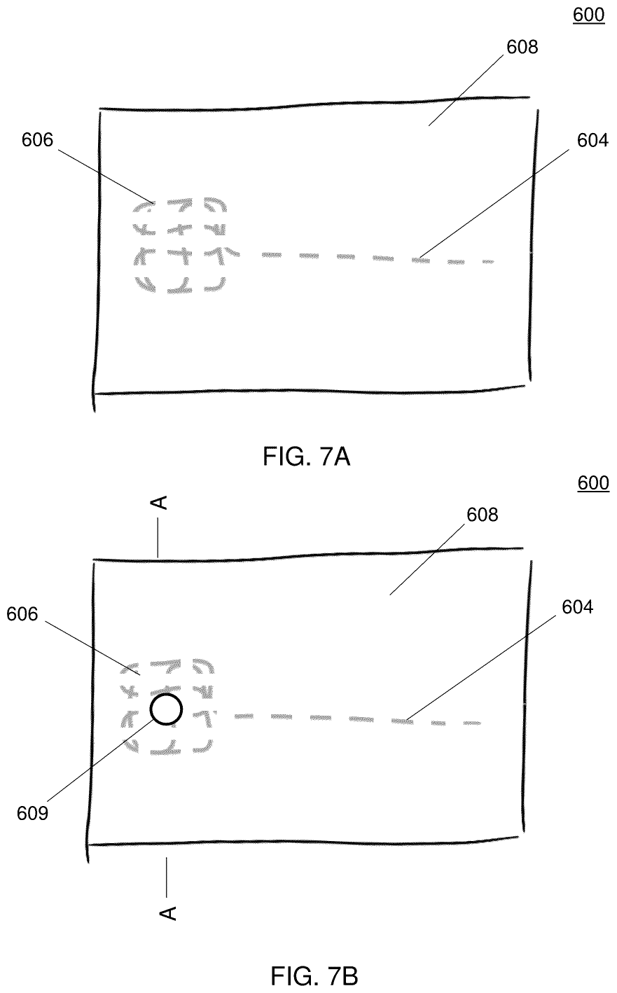

FIG. 6 is an exploded view of a layered composite structure 600 with a base substrate of a first layer of laminate material 602 with an embedded conductive fiber or wire 604 laid in a pattern on the base substrate 602 to provide electrical continuity across the composite structure 600. A conductive contact or pad area 606 is built up with overlying layers of the conductive fiber or wire 604 on the base substrate 602. The conductive contact or pad area 606 is shown as a square, however it is appreciated that any shape including non-limiting examples of a circle, triangle, rectangle, etc. may be used. The conductive fiber or wire 604 and the conductive contact or pad area 606 are covered by a second or upper layer 608 that sandwiches or embeds the conductors (604, 606).

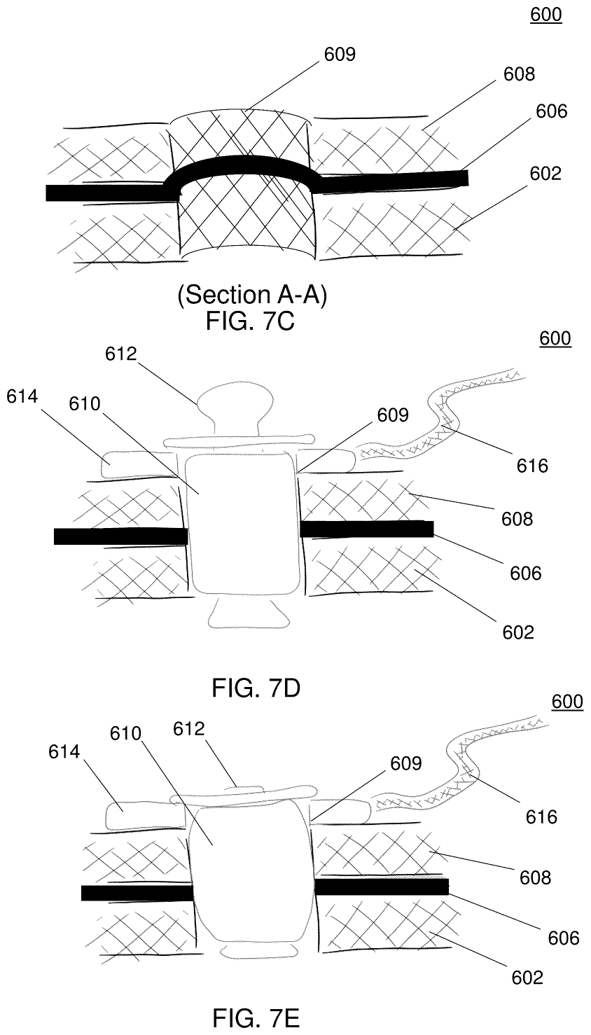

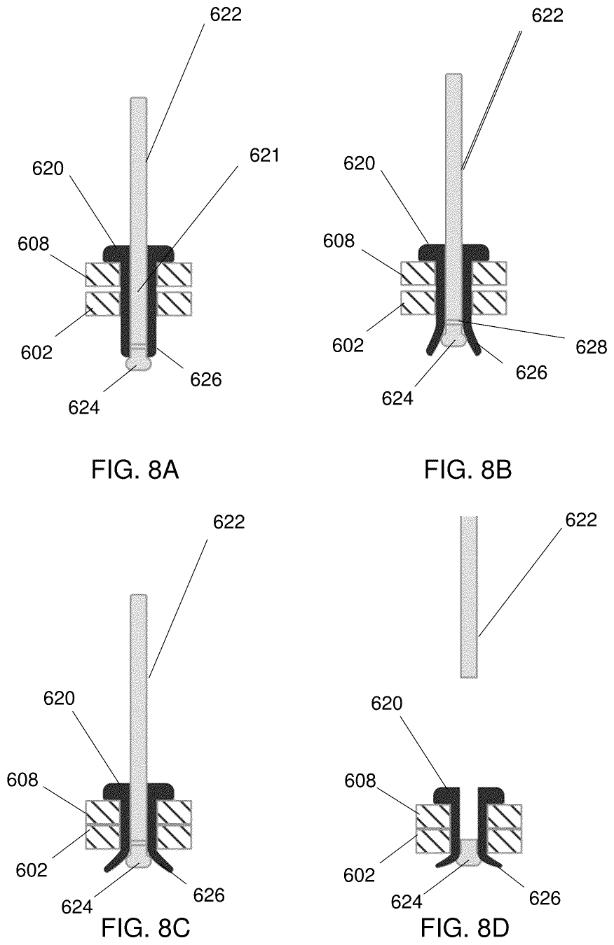

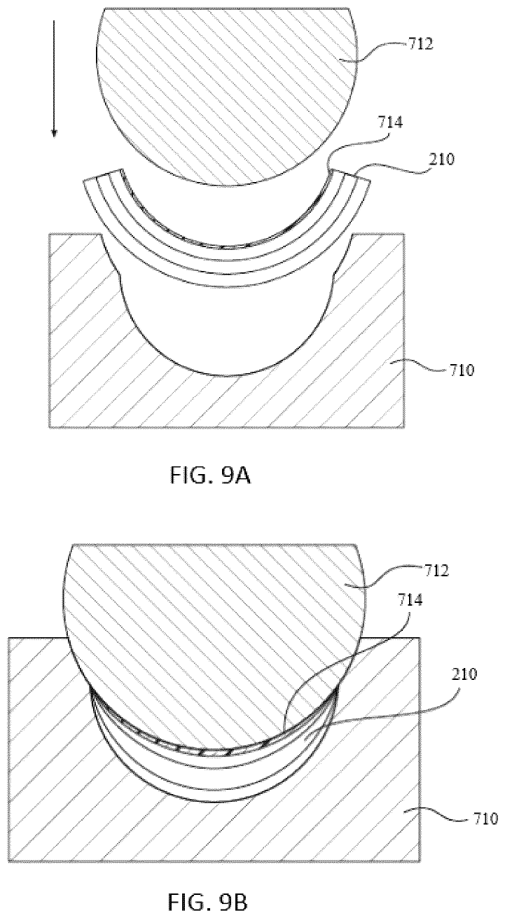

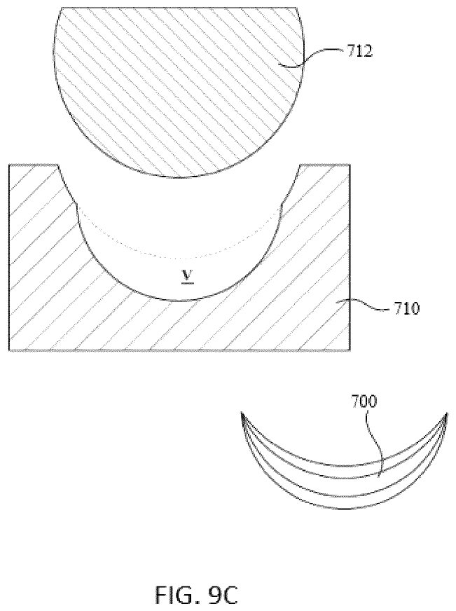

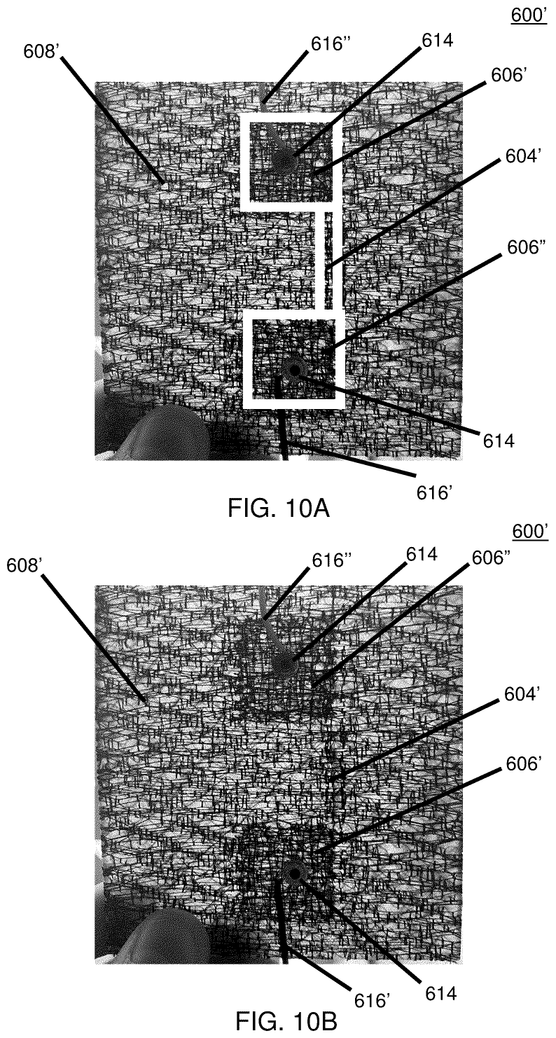

FIG. 7A is a top view of the layered composite structure 600 of FIG. 6 with the embedded conductive fiber or wire 604 and conductive pad area 606 shown as dashed lines as the conductors (604, 606) are covered by the second or upper layer 608. FIG. 7B illustrates a through hole aperture 609 made in the conductive pad area 606 of the embedded conductive fiber or wire 604 of the layered composite structure of FIG. 6. FIG. 7C is a partial cross section of the layered composite structure 600 of FIG. 7B along line A-A that illustrates the conductive contact or pad area 606 being intersected by the through hole aperture 609. A conductive fastener 610 is inserted into the through hole aperture 609 in the composite structure 600 and a stripped lead of an external wire 616 positioned for securement to a retaining portion or washer 614 of the conductive fastener 610 via a press fit. It is appreciated that if the conductive fastener 610 is a rivet, the retaining portion 614 is a rivet head which is forced toward the second or upper layer 608 when the tail 612 inserted in the body of the conductive fastener or rivet 610 is compressed. As shown in FIG. 7E the compression of the tail 612 results in the deformation of the cylindrical body of the rivet 610 outward expands the circumference of the rivet 610 in the aperture 609 and creates an interference fit in the aperture 609 that results in a secure electrical contact and engagement with the conductive pad area 606.

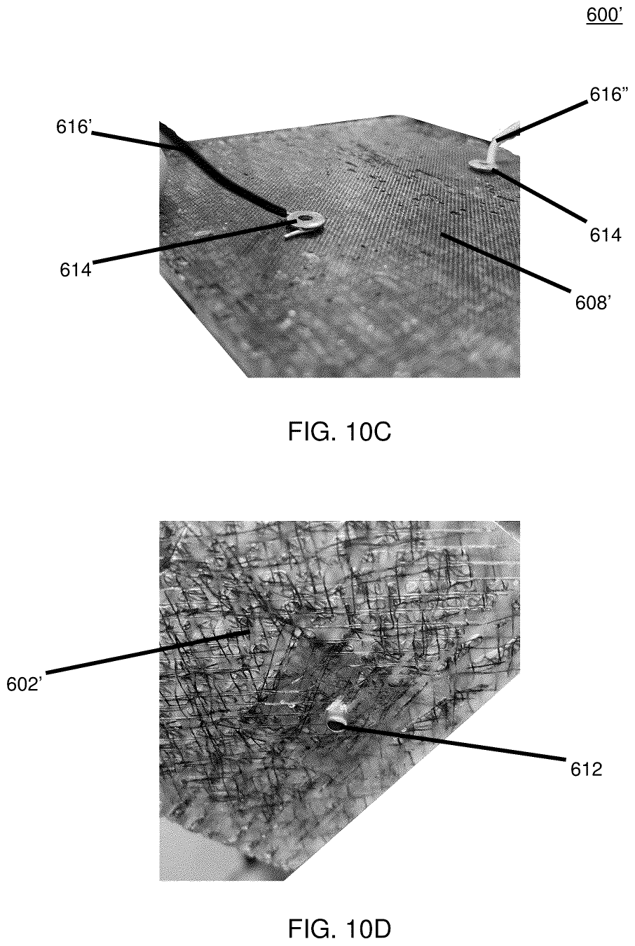

FIGS. 8A-8D are a series of partial cross-sectional views showing the insertion of a different conductive fastener or rivet 620 as a blind rivet. As shown in FIG. 8A, the cylindrical body 621 of the rivet 620 is inserted in the aperture 609 made in the layered composite structure 600. A mandrel 622 with an expanded head 624 is preinserted in the cylindrical body 621. As shown in FIG. 8B as the mandrel 622 is pulled upward with respect to the layered composite structure 600, the expanded head 624 is pulled inward into the cylindrical body 621 the blind end 626 is flared outward. In FIG. 8C as the mandrel 622 is continued to be pulled upward the flaring of the blind end 626 becomes more pronounced and the layers of the laminate materials (602, 608) are mechanically locked. In FIG. 8D as the resistive force on the mandrel 622 being pulled upward continues to increase, the mandrel 622 finally breaks along the score line 628 and leaving the rivet 620 firmly in place in the composite structure 600.

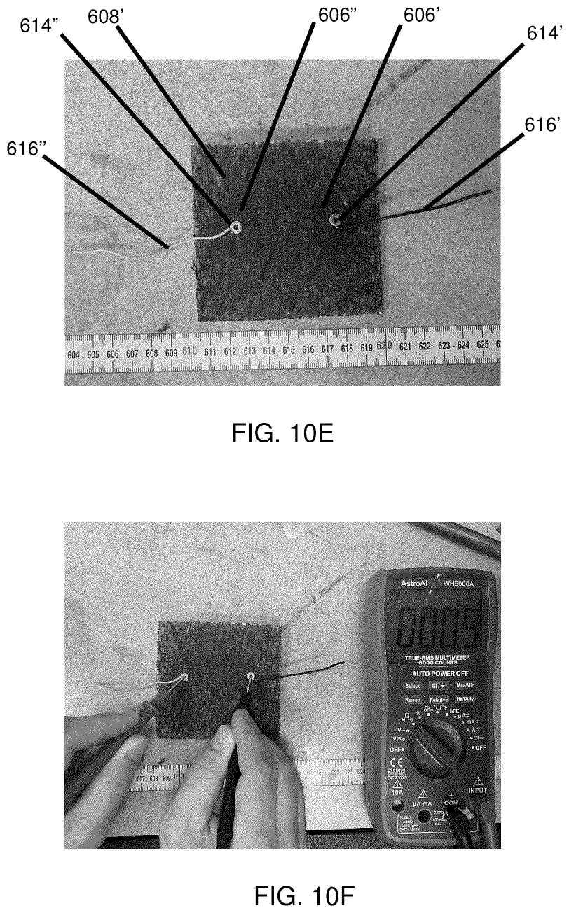

FIGS. 9A-9C are a series of schematics showing melt formation of a vehicle component 700. In FIG. 9A, form 210 is intended to be brought into simultaneous contact with opposing mold platens 710 and 712 that define a cavity volume, V. The volume V corresponding in shape to the desired vehicle component. By selectively heating one or both of the platens 710 or 712 to a temperature sufficient to melt any thermoplastic content of the form 210, but not the insulation surrounding the wiring 121, a vehicle component is formed upon cooling the mass compressed within the platens 710 and 712 by temperature and pressure, as shown in FIG. 9B. In a specific inventive embodiment, a thermoplastic veil 714 is in contact one or both platens 710 and 712 to create a skin on the resulting vehicle component. Upon opening the volume V, a completed vehicle component 700 is removed, as shown in FIG. 9C.

### EXAMPLES

### Example 1

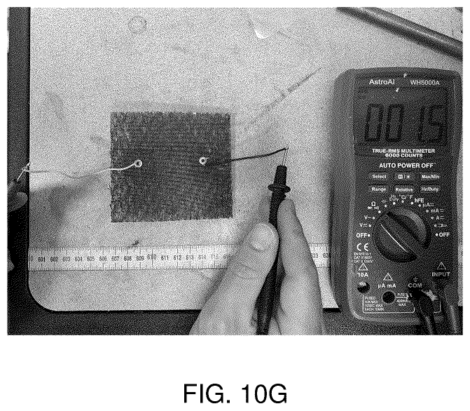

A fiberglass panel 600′ as shown in FIGS. 10A-10G was made with an embedded conductive circuit between layers of fiberglass (602′, 608′). FIG. 10A illustrates the electrical circuit in a superimposed white outline for visual identification and is also shown in FIG. 10B without the added white outline. A thirty-gauge copper wire was used to form interconnect wire 604′ and conductive pads (606′, 606″) that are connected by the wire 604′ to form the embedded circuit. As described above the contact or pad areas (606′, 606″) are built up with overlying layers of the conductive thirty-gauge copper wire 604′ on the base substrate 602′. The fiberglass panel 600′ with the conductive thirty-gauge copper wire 604′ layer sandwiched between the layers of fiberglass (602′, 608′) was molded to approximately 4 mm thickness at approximately 40% fiber volume fraction (FVF). A ⅛^{th} inch through hole was drilled through each of the two pad areas (606′, 606″) and a ⅛^{th} inch diameter copper pop rivet 614 was inserted in each through hole. As best shown in FIG. 10C, separate 22-gauge solid core pre-tinned copper wires (616′, 616″) were looped under each head of the pop rivets 614. As visible in the underside or blindside view of the fiberglass panel 600′ in FIG. 10D, a rivet gun (not shown) is used to pull and snap off the rivet mandrel in the manner shown in FIGS. 8A-8D. FIG. 10E provides an overall top view of the completed fiberglass panel 600′ with copper wires (616′, 616″) connected to the embedded circuit via rivets 614. FIG. 10F illustrates a manual resistance test of the embedded circuit at the contact points formed with the rivets 614 with a digital meter that shows an ohmic resistance of 0.9 ohms. FIG. 10G illustrates a manual resistance test of the embedded circuit taken at the ends of the attached wires (616′, 616″) with a digital meter that shows an ohmic resistance of 1.5 ohms.

The foregoing description is illustrative of particular embodiments of the invention, but is not meant to be a limitation upon the practice thereof. The following claims, including all equivalents thereof, are intended to define the scope of the invention.

1. A form for a vehicle component comprising:
a commingled fiber bundle composed of a reinforcement fiber, said reinforcement fiber being glass fibers, aramid fibers, carbon fibers, or a combination thereof, said commingled fiber bundle laid out in a two-dimensional base layer that defines a shape of the form;
a conductive fiber or wire laid in a pattern on said two-dimensional base layer to provide electrical continuity across the form;
at least one conductive contact or pad area built up with overlying layers of the conductive fiber or wire on said two-dimensional base layer;
a successive layer formed with said commingled fiber bundle in contact with said two-dimensional layer so as to embed said conductive fiber or wire and at least one conductive contact or pad area;
a through hole aperture corresponding to each of said at least one conductive contact or pad areas; and
a conductive fastener inserted into each of the through hole apertures, said conductive fastener in electrical communication with the corresponding conductive contact or pad area.

2. The form of claim 1 wherein said conductive fastener extends above an outer surface of said form and provides an external termination to said conductive contact or pad area.

3. The form of claim 1 wherein said conductive fastener extends above an outer surface of said form and provides an external termination for an external electrical harness function.

4. The form of claim 1 wherein said conductive fastener is a rivet.

5. The form of claim 4 wherein said rivet when expanded has an interference fit in the through hole aperture that results in a secure electrical contact and engagement with said conductive contact or pad area.

6. The form of claim 1 further comprising at least one of a sensor, a light emitting diode (LED), an antenna, a radio frequency identification chip, or a printed circuit board that is stitched to said successive layer.

7. The form of claim 1 wherein the commingled fiber bundle is further composed of thermoplastic fibers.

8. The form of claim 1 wherein said electrical conductive wiring is insulated.

9. The form of claim 1 wherein said electrical conductive wiring extends outward from said form as an electrical termination.

10. The form of claim 1 wherein the reinforcement fiber is exclusively only the glass fibers or the carbon fibers.

11. The form of claim 1 wherein the reinforcement fiber is enriched in carbon fiber in certain regions relative to glass fibers.

12. The form of claim 1 wherein said first successive layer is angularly displaced relative to said base layer.

13. The form of claim 1 wherein the form is formed using selective commingled fiber bundle positioning (SCFBP), where the form is held together with stitching of a thread.

14. The form of claim 13 wherein the thread is a thermoplastic thread, glass fiber thread, carbon fiber thread, aramid fiber thread, a metal wire, or a combination thereof.

15. The form of claim 1 wherein said commingled fiber bundle includes recycled fibers.

16. A method of forming a unitary reinforced composite component comprising:
placing the form of claim 1 onto a mold platen having a shape;
heating the form to the shape of the mold platen therein;
cooling the form until solidified; and
removing the shaped form from the mold platen.

17. The method of claim 16 further comprising applying a thermoplastic skin intermediate between the form and the mold platen.

18. The method of claim 16 further comprising applying a second opposing platen to apply pressure and sandwich the form.

19. The method of claim 16 wherein the unitary reinforced composite component is a vehicle component.

20. The method of claim 16 further comprising electrically connecting said electrically conductive fastener or said printed circuit board to an external electrical load.
